(19) United States
(12) Patent Application Publication
(10) Pub. No.: US 2016/0162368 A1
(43) Pub. Date: Jun. 9, 2016

(54) REMOTE STORAGE

(71) Applicant: HEWLETT-PACKARD DEVELOPMENT COMPANY, L.P., Houston, TX (US)

(72) Inventors: Alastair Slater, Bristol (GB); Dennis Suehr, Bristol (GB)

(21) Appl. No.: 14/905,287

(22) PCT Filed: Jul. 18, 2013
(86) PCT No.: PCT/US2013/050990

§ 371 Date: Jan. 15, 2016

(51) Int. Cl. G06F 11/14; G06F 17/30

(52) U.S. Cl. CPC G06F 11/1453; G06F 17/30312

(57) ABSTRACT

Remote storage of consumer data is achieved by processing consumer data for deduplication at a client computing system that includes creating metadata comprising information relating to a consumer directory tree structure of the consumer data, and transferring the deduplicated data and metadata for remote storage

### BACKGROUND

File systems may be used to organise data into computer file entities, namely directories and files, that may be stored, manipulated and retrieved using a computers operating system. For example, various versions of FAT (File Allocation Table) and NTFS (New Technology File System) ext (extended file system) are used with example operating systems. File systems relate the data of named files to locations in storage. The storage can comprise remote, physical storage devices such as, for example, hard disk drives, solid-state storage, tape storage, and CD-ROMs, and/or virtualised storage layered above such physical storage devices.

Virtual Tape Libraries (VTLs), for example, are connected to client computer systems via either internet Small Computer Systems Interface (iSCSI) or fibre channel (FC). With the arrival of compaction technology a large increase in the amount of stored data housed upon the VTL may occur.

### BRIEF DESCRIPTION OF DRAWINGS

For a more complete understanding, reference is now made to the following description taken in conjunction with the accompanying drawings in which:

FIG. 1 is a simplified schematic of an example computer system;

FIG. 2 is a simplified schematic of an example client computer system of the example of FIG. 1;

FIG. 3 is a simplified schematic of an example controller of the example of FIG. 1;

FIG. 4 is a simplified schematic of an example storage facility of the example of FIG. 1;

FIG. 5 is an example of a consumer directory tree structure;

FIG. 6 is a flowchart of an example of a method of controlling remote storage of consumer data;

FIG. 7 is a flowchart of an example of a method of providing a consumer directory of a remote file system;

FIG. 8 is a flowchart of an example of creating a root directory;

FIG. 9 is a flowchart of an example of creating a directory object;

FIG. 10 is a flowchart of an example of providing a consumer directory of a remote file system of FIG. 7 in more detail;

FIG. 11 is a flowchart of an example of moving objects within a consumer directory tree structure; and

FIG. 12 is a flowchart of an example of setting a parent directory for an object.

### DETAILED DESCRIPTION

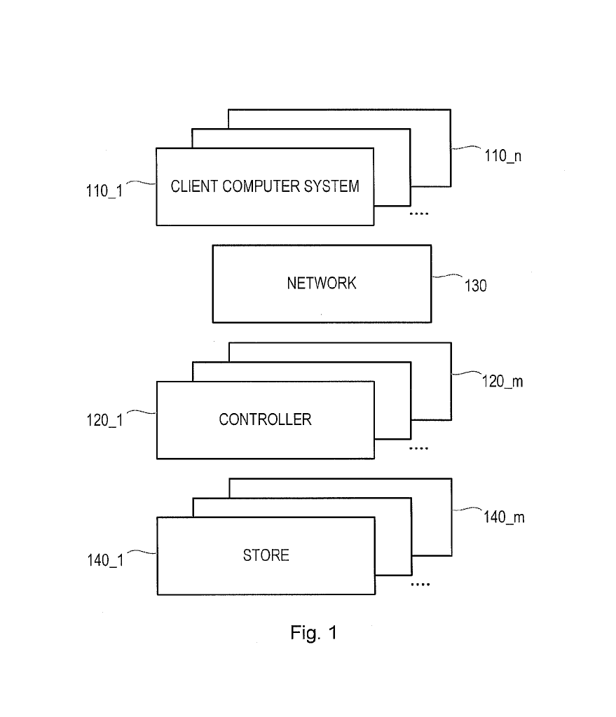

Referring to FIG. 1, a plurality of client computer systems 110_1 to 110_n communicate with at least one controller 120_1 to 120_m via a network 130. The network 130 comprises, for example, an Ethernet network such as Gigabit Ethernet LAN, or other types of networks. The at least one controller 120_1 to 120_m includes or communicates with respective mass storage 140_1 to 140_m.

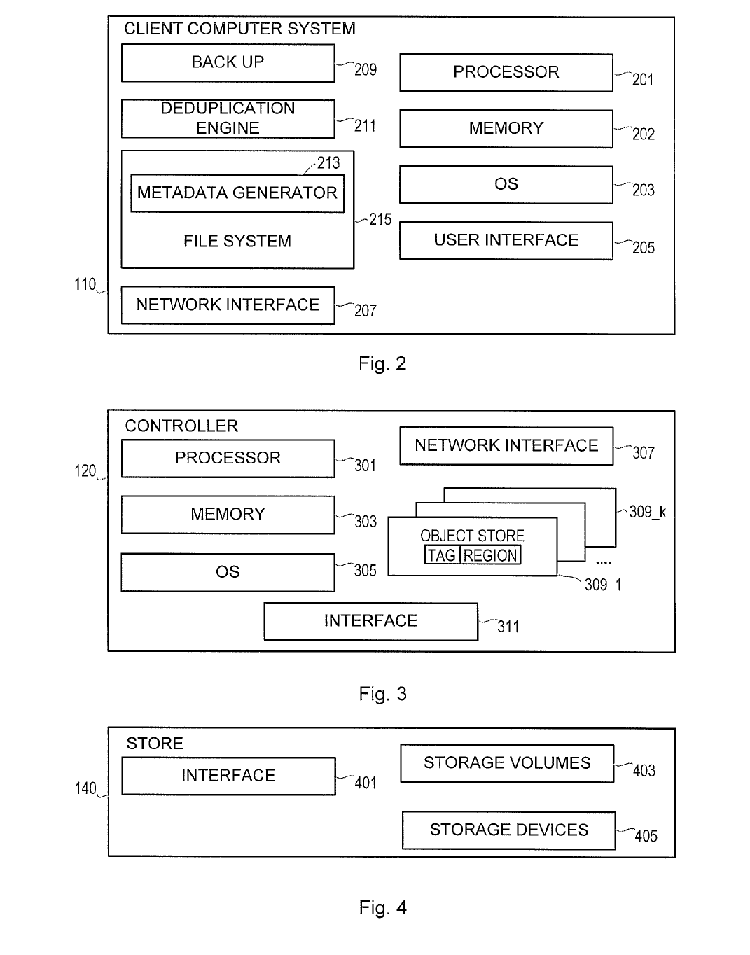

FIGS. 2 to 4 are functional representations of the client computer system 110, the controller 120 and the mass storage 140. The client computer system 110 includes processor resource 201 comprising a processor such as a CPU (central processing unit), or a combination of processors, and a memory 202 comprising, for example, volatile memory such as DRAM, and/or non-volatile memory such as EEPROM, and/or any convenient alternative type of memory/storage in any convenient form and physical arrangement. The client computer system 110 further comprises an operating system 203 to execute various consumer applications on the client computer system 110. The client computer system 110 also includes a user interface 205, for example, a display monitor, keyboard, mouse, touch screen and/or the like.

A network interface 207 is also included in the client computer system 110 for communicating over the network 130. The network interface 207 may, for example, comprise an adapter, for example an NIC (network interface controller), suited to the network.

The client computer system 110 further comprises a backup application 209 which is executed to provide backup copies of consumer data, a deduplication engine 211 for dividing the consumer data to be backed up into chunks and determining a hash function for each chunks for processing the consumer data for deduplication before backup copies of the consumer data are transferred to back up storage facilities on the mass storage 140.

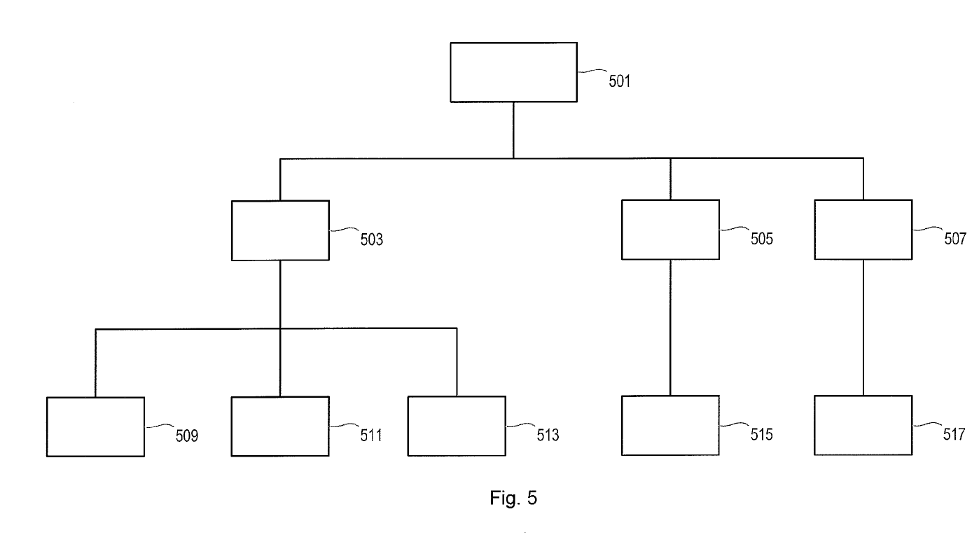

The client computer system 110 further comprises a file system 215 for organising consumer data into file entities (or objects) in a directory tree structure, as shown for example in FIG. 5. For example, the directory tree structure comprises a top-level (root) directory 501 associated with, or containing, first, second and third lower-level directories 503, 505, 507. The first lower-level directory 503 is associated with, or contains, first, second and third leaf directories 509, 511, 513. Each leaf directory 509, 511, 513 may be associated with, or contain, files.

The file system 215 includes a metadata generator 213 for generating metadata which includes information of the objects of the tree structure including the type of object and its relative relationship with the other objects within the tree structure. For example, the metadata may comprise a unique universal identifier (UUID) for each object and if that object has a parent object, the metadata for that object also includes the parent UUID. In the example shown in FIG. 5, for example, the root directory 501 has an UUID and a parent UUID of NULL, identifying the object as a root directory. The first lower-level directory 503 has its own UUID and a parent UUID of the root directory 501.

The controller 120, as shown in FIG. 3, comprises a processor resource 301, a memory 303 and operating system 305 to perform general functions and services of the control system including comparison of the hash functions of each chunk to remove duplicated chunks from the consumer data and proceeding with transfer for storage of deduplicated data. The controller 120 also includes a network interface 307 (e.g. NIC), a plurality of object stores 309_1 to 309_k and an interface 311 connected to a corresponding interface 401 of respective mass storage 140_1 to 140_m to physically store the deduplicated consumer data. The mass storage 140 includes physical storage such as hard disk drives, and/or solid state storage, and/or tape, and in some examples includes a virtualisation entity 403, 405 such as a RAID controller to provide virtual storage volumes. The type of interfaces 311, 401 employed can vary as appropriate according to whether the mass storage 140 is included in a physical enclosure with the controller 120, or directly externally attached, or attached over a storage network or LAN.

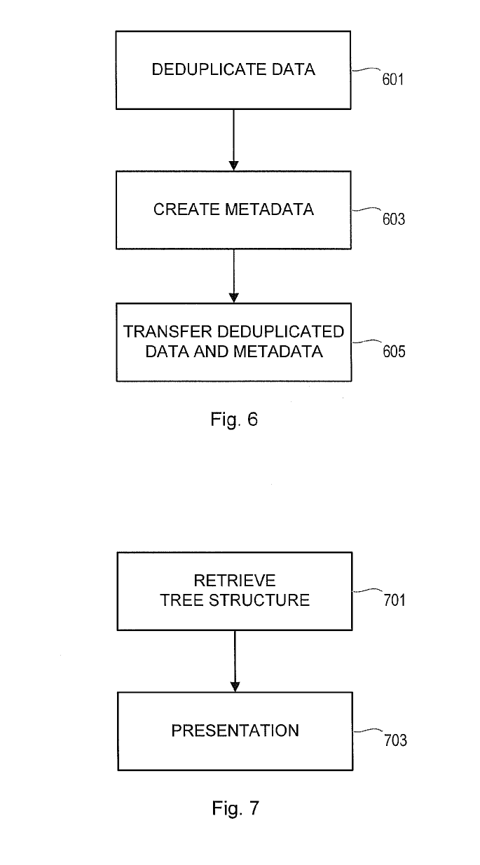

Operation of the system will now be described in more detail with reference to FIGS. 5 to 10. The backup application 209 of a client computer system 110 is initiated and consumer data stored in memory 202 is retrieved for copying to a backup facility within the mass storage 140 at a location remote from the client computer system 110 via the network 130 and the controller 120. The consumer data is deduplicated, 601. This process is initiated by the deduplication engine 211 by dividing the consumer data stream into a plurality of chunks. A collision resistant hash function is determined for each chunk. The hash functions are compared with hash functions of the data already stored by the mass storage 140 by the processor 301. The processor 301 accesses a store of previous deduplicated data chunks or lists or manifests of data chunk locations. Chunks which have already been stored are replaced with a pointer to the previously stored chunk. The deduplication engine 211 of the client computer system, in dividing the data into chunks and applying the hash function, reduces the demand on the processor resource 301 of the controller. Further, in alternative arrangement, only new chunks need be transferred from the client computer system to the controller.

The metadata generator 213 then creates, 603, the metadata based on the consumer directory tree structure. This is achieved by the notion of a parent UUID (unique universal identifier) and an object UUID for each object. These UUIDs may be stored in the ‘tags’ region 313 of the current Object store schema for each object. Although this example utilises an Object store schema, it can be appreciated that different unique storage schema may be utilised.

The UUID of the object may also be set as the key of the object, rather than an incremental datum. Along with the incremental notion of an object stored in an Object store having a ‘parent’, the notion of a ‘root’ object is provided having a NULL parent UUID. This provides a point to start navigating relationships between objects, and hence facilitating a file system type mapping.

Along with the parent UUID and own UUID of each object, additional states may be stored per object that allows specification of the type of objects in an object store. It is intended that the storage of such “type” information allows the client links, etc. Thus there is the use of an Object store object solely as a means of storing metadata about a presentation (e.g. file system in the most likely instance); the use of such objects being readily used to provide the presentation of directories (container objects), special files (symbolic links) etc.

The deduplicated data (or data to be further processed for deduplication) and metadata is then transferred, 605, over the network 130 to the controller 120. The metadata is stored in the tag regions 313 of one of the object stores 309_1 to 309_k. The deduplicated data is located and stored on the mass storage 140.

As a result, some processing of the data for deduplication is carried out on the client computer system to reduce the demand on the processor resource of the controller. Further, the bandwidth for transferring the data from the client computer system is not wasted by transferral of redundant data which, when it arrives at the controller 120, it is already found to have been stored since the consumer data may be deduplicated before transferral since the controller 120 may only transfer the non duplicated chunks. An update count of duplicated chunks is incremented such that no chunks are unreferenced. This update is transferred to the controller.

The tree structure can then be retrieved, 701, from the controller 130 by a client computer system 110 using the metadata stored in the object store and presented, 703 to the user via the user interface 205.

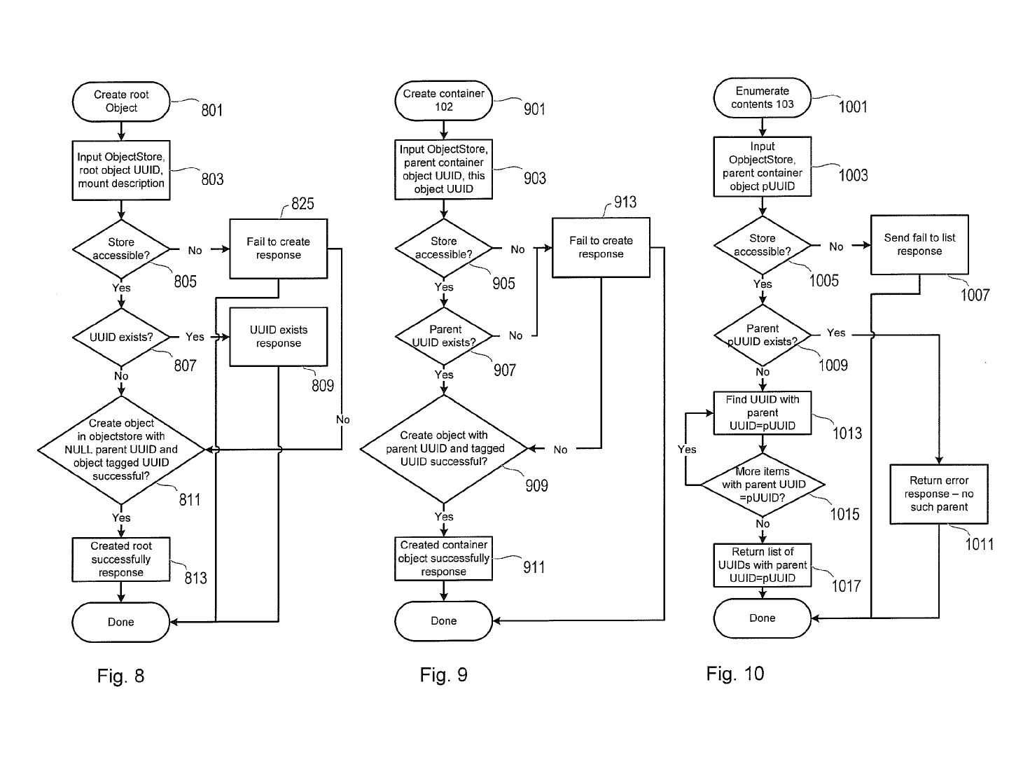

Referring to FIG. 8, a root directory (or root container object), for example, the root directory 501 of FIG. 5, is created 801. A UUID is created and input, 803, into the object store. If the store is accessible, 805, it is established whether the UUID exists, 807. If the UUID exists, a corresponding response is issued, 809. If the UUID does not exist, the root directory object is created, 811, with a NULL parent UUID and if the root directory object is successfully tagged, a corresponding response is issued, 813. If the store is not accessible or the object is not tagged successfully, a failure response is issued, 815.

Setting an object O, such as a file entity, to have a parent UUID, 1201, is shown in FIG. 12. The parent container UUID and the object UUID object O are input, 1203, into the object store. If the store is not accessible, 1205, and the object does not exist, 1207, a failure response is issued and the object O is left intact, 109. Otherwise, it is determined whether the parent object exists and if it is container, 1211. If it does not exist, a corresponding response is issued, 1213 and the object O is left intact. Otherwise the parent container of the object UUID is tagged, 1215 and if successful, a corresponding response is issued, 1217. Otherwise, a failure response is generated, 1219 and the object O is left intact.

It will be appreciated that the use of the metadata as described above allows the storage of multiple presentations within one Object store (and hence deduplication domain), hence allowing consumers the ability to deduplicate differing file systems against one another, and hence reduce overall stored data on the controller 120 and to reduce the bandwidth in transferring data across the network 130.

In order to navigate a set of objects, one starts at a known points in the relationship hierarchy (root for the sake of argument); and then the contents can be enumerated, 1001, by the technique shown in FIG. 10, for example, so as to navigate/provide a listing of objects (and hence provide the consumer's view of files/directories for presentation to the user. It will readily be appreciated that this can be utilised recursively to enumerate the contents of an entire hierarchy in a depth first manner. The starting point for navigation, the parent UUID of the object directory is input, 1003, into the object store. If the store is not accessible, 1005, a failure response is issued, 1007. If the parent UUID does not exist in the Object store, 1009, a corresponding response is issued, 1011. All objects having the corresponding parent UUID associated therewith is returned and listed, 1013, 1015, 1017.

In order to present a view of objects that a file system navigator might expect (typically what is provided in a Unix stat structure per file for example) in which case additional data over and above the UUIDs may be stored, to enable such a view per object to be derived (typically permissions bits, but by no means limited to that solely—may also include data fields for ACLs/extended attributes/leaf-name of object, etc).

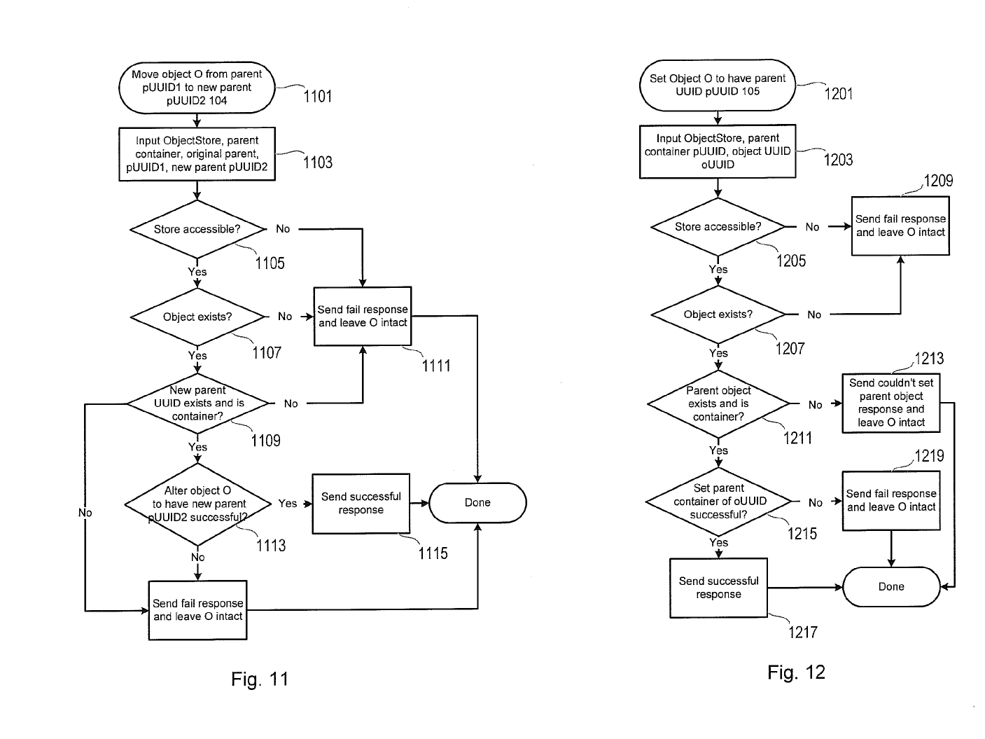

Moving files, 1101, on the client computer system 110 around the presentation of the directory tree structure likewise becomes a simple matter as illustrated in FIG. 11. An object O is to be moved from a first parent to a second parent. The first and second parent UUIDs are input into the Object store, 1103. If the store is not accessible, 1105, or the object O does not exist, 1107, or the second parent UUID does not exist, 1109, a failure response is issued, 1111 and object O metadata is not altered. If the store is accessible and the object exists and the second parent UUID exits, the metadata of object O is altered to change the first parent UUID to the second parent UUID, and if successful, 1113, a corresponding response is issued 1115 and if not, a failure response is issued and the object O is unaltered, 1117. Likewise a bulk move is automatable via similar means—for all objects with a matching parent UUID, initiate the process of FIG. 11.

In another example, the techniques can handle a situation where a ‘valid’ container is suggested initially to be an object store object that has no backing data in the mass storage. The metadata can readily provide an indication of ‘containerness’ along with the other incremental data being stored per object.

A container can be created, 901, as shown in FIG. 9. If the store is accessible, 905, and the object exists, 907, and the object is successfully tagged, 909, a corresponding response is issued, 911. Otherwise, a failure response is issued, 913.

As a result, the directory structure can be represented by metadata solely housed within the Object store, rather than requiring any client side storage. Therefore, metadata will not be lost following failure of the client computer system and therefore, the backup data and the directory tree structure are completely recoverable from the mass storage 140 and the object store.

As a result, a client computer system (or host) without any unique software other than the usual ISV (independent software vendor) application can perform a restore from the mass storage 140. Further, since the metadata is not stored on the client computer system more consumer usable disaster recovery solutions can be utilised in combination with the system described above.

Any of the features disclosed in this specification, including the accompanying claims, abstract and drawings, and/or any of the steps of any method or process so disclosed, may be combined in any combination, except combinations were the sum of such features and/or steps are mutually exclusive. Each feature disclosed in this specification, including the accompanying claims, abstract and drawings may be replaced by alternative features serving the same, equivalent or similar purpose, unless expressly stated otherwise. Thus, unless expressly stated otherwise, each feature disclosed is one example only of a generic series of equivalent or similar features. The techniques of the present application are not restricted to the details of any foregoing examples. The claims should not be construed to cover merely the foregoing examples, but also any examples which fall within the scope of the claims. The techniques of the present application extend to any novel one, or any novel combination, of the features disclosed in this specification, including the accompanying claims, abstract and drawings, or to any novel one, or any novel combination, of the steps of any method or process so disclosed.

It will be appreciated that examples can be realized in the form of hardware, software module or a combination of hardware and the software module. Any such software module, which includes machine-readable instructions, may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of a non-transitory computer-readable storage medium that are suitable for storing a program or programs that, when executed, for example by a processor, implement embodiments. Accordingly, embodiments provide a program comprising code for implementing a system or method as claimed in any preceding claim and a non-transitory computer readable storage medium storing such a program.

1. A method of controlling remote storage of consumer data, the method comprising:
processing consumer data for deduplication at a client computer system;
creating metadata comprising information relating to a consumer directory tree structure of the consumer data; and
transferring the deduplicated data and metadata for remote storage.

2. The method of claim 1, wherein the consumer data comprises a plurality of file entities, the file entities being organised into the consumer directory tree structure, the consumer directory tree structure and file entities and their relative relationships being defined by objects, the metadata comprising information relating to the objects.

3. The method of claim 2, wherein the method further comprising:
storing the processed consumer data and metadata at a remote location in at least one object store.

4. The method of claim 3, wherein creating metadata comprises:
creating unique universal identifiers for each object; and
adding the unique universal identifier of a parent object, if one exists, for each object or a NULL identifier if a parent object does not exist for that object.

5. The method of claim 4, wherein storing the created metadata comprises:
storing the created metadata within tag regions of the object store schema.

6. The method of claim 1, wherein processing consumer data for deduplication comprises:
dividing the consumer data into a plurality of chunks; and
determining a hash function of each chunk.

7. A controller for controlling remote storage of consumer data, the controller comprising:
a first interface to receive deduplicated consumer data and metadata, the metadata comprising information relating to a consumer directory tree structure of the consumer data;
a store to store the received metadata; and
a second interface to transfer the received deduplicated consumer data to a storage device.

8. The controller of claim 7, wherein the consumer data comprises a plurality of file entities, the file entities being organised into the consumer directory tree structure, the consumer directory tree structure and file entities and their relative relationships being defined by objects, the metadata comprising information relating to the objects.

9. The controller of claim 8, wherein the controller further comprises
an object store to store the transferred deduplicated data and metadata.

10. The controller of claim 9, wherein the metadata comprises an unique universal identifiers for each object; and an unique universal identifier of a parent object, if one exists, for that object or a NULL identifier if a parent object does not exist for that object.

11. The controller of claim 10, wherein the object store comprises
a plurality of tag regions, the tag regions storing the received metadata.

12. A non-transitory computer medium having computer readable instructions stored thereon to cause a processor to:
process consumer data for deduplication at a client computer system;
create metadata comprising information relating to a consumer directory tree structure of the consumer data; and
transfer the deduplicated data and metadata for remote storage.

13. The medium of claim 12, wherein computer readable instructions stored thereon to cause a processor further to:
store the processed consumer data and metadata at a remote location in at least one object store.

14. The medium of claim 13, wherein creating metadata comprises:
creating unique universal identifiers for each object; and
adding the unique universal identifier of a parent object, if one exists, for each object or a NULL identifier if a parent object does not exist for that object.

15. The medium of claim 14, wherein storing the created metadata comprises:
storing the created metadata within tag regions of the object store schema.
